(19) United States
(12) Patent Application Publication
(10) Pub. No.: US 2025/0348689 A1
(43) Pub. Date: Nov. 13, 2025

(54) INFORMATION PROCESSING APPARATUS, RESPONSE METHOD, AND STORAGE MEDIUM

(71) Applicant: NEC Corporation, Tokyo (JP)

(72) Inventors: Masahiro SERIZAWA, Tokyo (JP); Masahiro IWADARE, Tokyo (JP); Akio YOSHIOKA, Tokyo (JP); Shinnosuke NISHIMOTO, Tokyo (JP)

(73) Assignee: NEC Corporation, Tokyo (JP)

(21) Appl. No.: 19/200,850

(22) Filed: May 7, 2025

(30) Foreign Application Priority Data
May 13, 2024 (JP) 2024-077805

(51) Int. Cl. G06F 40/40; G06F 40/20

(52) U.S. Cl. CPC G06F 40/40; G06F 40/20

(57) ABSTRACT

In order to responsiveness in an interaction using a language model, in an information processing apparatus, in a case where a reception unit receives a second utterance in a period from a time when a first utterance is received to a time when presentation of a first response to the first utterance is completed, a generation control unit starts generation of a second utterance based on the second utterance and a presentation unit presents, to a user, the second response generated.

This Nonprovisional application claims priority under 35 U.S.C. § 119 on Patent Application No. 2024-077805 filed in Japan on May 13, 2024, the entire contents of which are hereby incorporated by reference.

### TECHNICAL FIELD

The present disclosure relates to an information processing apparatus, a response method, and a storage medium.

### BACKGROUND ART

There has been known a technology to cause an information processing apparatus to respond in natural language to a user of the information processing apparatus, with use of a language model which has been generated by machine learning of the natural language. For example, a sentence generation device disclosed in Patent Literature 1 causes a large language model to generate a response sentence in response to a question sentence which has been inputted via a user terminal, and to output, to the user terminal, the response sentence generated.

### CITATION LIST

### Patent Literature

### [Patent Literature 1]

Japanese Patent No. 7313757

### SUMMARY OF INVENTION

### Technical Problem

The sentence generation device disclosed in Patent Literature 1 has room for improvement in terms of responsiveness in an interaction with a user. Assume, for example, a case in which in an interaction using the above sentence generation device, a user recognizes that there was an error in content of a question that the user inputted. In this case, the user needs to wait for presentation of a response to the question which was previously inputted, and after the response is presented, input a new question and obtain a response. In this case, a waiting time that is not short occurs before the user obtains a desired response.

The presence of such room for improvement is not limited to the case of the sentence generation device. Such room for improvement is commonly present in cases in which interactions are performed with use of a language model. An example object of the present disclosure is to provide a technique for making it possible to improve responsiveness in an interaction using a language model.

### Solution to Problem

An information processing apparatus in accordance with an example aspect of the present disclosure is an information processing apparatus that makes it possible to respond in natural language to a user with use of a language model trained by machine learning, the information processing apparatus including at least one processor, the at least one processor carrying out: a reception process of receiving an utterance of the user; a generation control process of causing the language model to generate a response to the utterance that has been received; and a presentation process of presenting, to the user, the response generated, in a case where the at least one processor receives a second utterance in a period from a time when a first utterance is received to a time when presentation of a first response to the first utterance is completed, the at least one processor starting generation of a second response based on the second utterance and presenting, to the user, the second response generated.

A response method in accordance with an example aspect of the present disclosure is a response method that makes it possible to respond in natural language to a user with use of a language model trained by machine learning, the response method including: at least one processor carrying out a reception process of receiving an utterance of the user; the at least one processor carrying out a generation control process of causing the language model to generate a response to the utterance that has been received; and the at least one processor carrying out a presentation process of presenting, to the user, the response generated, in a case where the at least one processor receives a second utterance in a period from a time when a first utterance is received to a time when presentation of a first response to the first utterance is completed, the at least one processor starting generation of a second response based on the second utterance and presenting, to the user, the second response generated.

A storage medium in accordance with an example aspect of the present disclosure is a storage medium storing a response program for making it possible to respond in natural language to a user with use of a language model trained by machine learning, the response program causing a computer to carry out: a reception process of receiving an utterance of the user; a generation control process of causing the language model to generate a response to the utterance that has been received; and a presentation process of presenting, to the user, the response generated, in the reception process, in a case where a second utterance is received in a period from a time when a first utterance is received to a time when presentation of a first response to the first utterance is completed, the computer being caused to start generation of a second response based on the second utterance and to present, to the user, the second response generated.

### Advantageous Effects of Invention

An example aspect of the present disclosure yields an example advantage of making it possible to improve responsiveness in an interaction using a language model.

### BRIEF DESCRIPTION OF DRAWINGS

FIG. 1 is a block diagram illustrating a configuration of an information processing apparatus in accordance with the present disclosure.

FIG. 2 is a flowchart illustrating a flow of a response method in accordance with the present disclosure.

FIG. 3 is a block diagram illustrating a configuration of another information processing apparatus in accordance with the present disclosure.

FIG. 4 is a diagram illustrating an example of an interaction in text.

FIG. 5 is a diagram illustrating an example of an interaction with sound.

FIG. 6 is a flowchart illustrating an example of a flow of a series of example processes which are carried out by the information processing apparatus illustrated in FIG. 3.

FIG. 7 is a block diagram illustrating a configuration of a computer that functions as the information processing apparatus in accordance with the present disclosure.

### DESCRIPTION OF EMBODIMENTS

The following description will discuss example embodiments of the present invention. Note, however, that the present invention is not limited to the example embodiments described below, but can be altered in various ways by a person skilled in the art within the scope of the claims. For example, the present invention can also encompass, in its scope, any example embodiment derived by appropriately combining techniques (some or all of products or processes) employed in the example embodiments described below. Further, the present invention can also encompass, in its scope, any example embodiment derived by appropriately omitting some of the techniques employed in the example embodiments described below. Furthermore, effects mentioned in the example embodiments described below are example advantages expected in the example embodiments described below, and are not intended to define an extension of the present invention. That is, the present invention can also encompass, in its scope, any example embodiment that does not bring about any of the example advantages mentioned in the example embodiments described below.

### First Example Embodiment

The following description will discuss a first example embodiment, which is an example embodiment of the present invention, in detail with reference to the drawings. The present example embodiment is a basic form of example embodiments described later. Note that the scope of application of techniques which are employed in the present example embodiment is not limited to the present example embodiment. That is, techniques which are employed in the present example embodiment can be employed also in the other example embodiments included in the present disclosure, provided that no particular technical problem occurs. Moreover, techniques which are indicated in the drawings referred to for describing the present example embodiment can be employed also in the other example embodiments included in the present disclosure, provided that no particular technical problem occurs.

### (Configuration of Information Processing Apparatus 1)

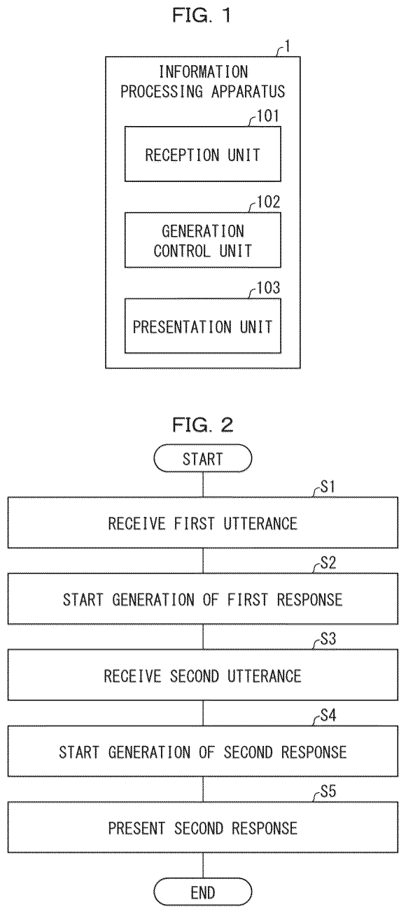

A configuration of an information processing apparatus 1 in accordance with the present example embodiment will be described with reference to FIG. 1. FIG. 1 is a block diagram illustrating the configuration of the information processing apparatus 1. The information processing apparatus 1 makes it possible to respond in natural language to a user, with use of a language model which has been trained by machine learning, that is, makes it possible to receive input in natural language and make a response in the natural language. The information processing apparatus 1 includes a reception unit 101, a generation control unit 102, and a presentation unit 103, as illustrated in FIG. 1.

The reception unit 101 receives an utterance of a user. The “utterance” herein is defined to include not only what is uttered in voice but also what is inputted as text. In other words, the reception unit 101 may receive, as an utterance, input of audio data or may receive, as an utterance, input of text data. In a case where the reception unit 101 receives input of audio data, the reception unit 101 may convert the audio data into text data. Note that it is possible to provide, in the information processing apparatus 1, a processing block that is different from the reception unit 101 and cause the processing block to carry out conversion into text data, or to cause another apparatus which is different from the information processing apparatus 1 to carry out conversion into text data. Further, content of the utterance is arbitrary, and may be, for example, an utterance for conversation, an utterance for asking a question, or an utterance for giving an order.

The generation control unit 102 causes the language model to generate a response to the utterance which has been received by the reception unit 101. The language model may be any model, provided that the model is generated by machine learning so as to be capable of generating a response to an utterance of a user. For example, it is possible to use, as the language model, a general-purpose language model that has learned, by machine learning, an arrangement of components (such as words) of a sentence described in natural language and an arrangement of sentences in text. The language model may be included in the information processing apparatus 1 or may be an apparatus which is included in another apparatus. In the latter case, the generation control unit 102 transmits, to the another apparatus, the audio data or text data that indicates the content of the utterance which has been received by the reception unit 101, and acquires, from the another apparatus, a response which has been generated by the language model.

The presentation unit 103 presents, to the user, the response which has been generated under control of the generation control unit 102. The response may be presented in an arbitrary manner. For example, the presentation unit 103 may present the response which has been generated, by causing an audio output apparatus to perform audio output of the response or causing a display apparatus to perform display output of the response. Note that the audio output apparatus and the display apparatus for use in presentation of the response may be provided in the information processing apparatus 1 or in another apparatus.

It is assumed here that the reception unit 101 receives a second utterance in a period from a time when a first utterance is received to a time when presentation of a first response to the first utterance is completed. In this case, the generation control unit 102 starts generation of a second response based on the second utterance. Then, the presentation unit 103 presents, to the user, the second response thus generated.

Note here that the “first utterance” is an utterance that is immediately preceding the “second utterance” and does not necessarily mean the first utterance in an interaction. For example, one utterance uttered during an interaction may be set as the “first utterance”. In this case, an utterance following the one utterance becomes the “second utterance”.

Further, the presentation unit 103 may be configured to present the first response in order from a generated portion of the first response, in the period from the time when the first utterance is received to the time when presentation of the first response to the first utterance is completed. The same applies to the second response. The presentation unit 103 may the second response in order from a generated portion of the second response. Moreover, the generation control unit 102 may discontinue or continue generation of the first response at a time when generation of the second utterance is started.

Furthermore, the second response only needs to be generated on the basis of the second utterance. For example, the generation control unit 102 may input the second utterance as is to the language model and generate the second response, or may input both of the first utterance and the second utterance to the language model and generate the second utterance. Alternatively, for example, the generation control unit 102 may input, to the language model, the second utterance which has been processed, and generate the second response.

As described above, the information processing apparatus 1 makes it possible to respond in natural language to a user with use of a language model trained by machine learning. This information processing apparatus 1 includes a reception unit 101 that receives an utterance of a user, a generation control unit 102 that causes the language model to generate a response to the utterance that has been received, and a presentation unit 103 that presents, to the user, the response generated. Then, in a case where the reception unit 101 receives a second utterance in a period from a time when a first utterance is received to a time when presentation of a first response to the first utterance is completed, the generation control unit 102 starts generation of a second response based on the second utterance. Then, the presentation unit 103 presents, to the user, the second response generated.

In the above configuration, the user can make the second utterance and receive presentation of the second response based on the second utterance, without waiting for presentation of the response to the first utterance or making an operation for discontinuation of the response to the first utterance. In this way, the information processing apparatus 1 can yield an example advantage of making it possible to improve responsiveness in an interaction using the language model.

### (Response Program)

Functions of the information processing apparatus 1 above can be realized by a program. A response program in accordance with the present example embodiment is a response program for making it possible to respond in natural language to a user with use of a language model trained by machine learning, the response program causing a computer to function as: a reception means that receives an utterance of the user; a generation control means that causes the language model to generate a response to the utterance that has been received; and a presentation means that presents, to the user, the response generated, in a case where the reception means receives a second utterance in a period from a time when a first utterance is received to a time when presentation of a first response to the first utterance is completed, the generation control means starting generation of a second response based on the second utterance and the presentation means presenting, to the user, the second response generated. This response program makes it possible to improve responsiveness in an interaction using a language model.

### (Flow of Response Method)

A flow of a response method in accordance with the present example embodiment will be described below with reference to FIG. 2. FIG. 2 is a flowchart illustrating the flow of the response method. Note that steps of the response method may be carried out by a processor of the information processing apparatus 1 or by a processor of another apparatus. Alternatively, the steps may be carried out by processors provided in respective different apparatuses.

In S1 (reception process), at least one processor receives input of a first utterance from a user. The first utterance may be inputted as audio data or text data.

In S2 (generation control process), the at least one processor causes the language model to start generating a first response to the first utterance which has been received in S1. Note that the at least one processor may be configured to present the first response that is generated by the language model in order from a generated portion, or present the first response at the time point at which the generation of the first response has been completed.

In S3 (reception process), the at least one processor receives input of a second utterance from the user. Note that FIG. 2 illustrates an example in which timing of reception of the second utterance is in a period from a time when the first utterance is received to a time when presentation of the first response to the first utterance is completed.

In S4 (generation control process), the at least one processor starts generation of a second response based on the second utterance.

In S5 (a presentation process), the at least one processor presents, to the user, the second response that has been generated under control in S4. With this presentation, a series of processes in FIG. 2 ends. Note that the process of S5 may be started immediately after the start of the process of S4. In other words, the at least one processor may be configured to present the second response that is generated by the language model in order from a generated portion, or present the second response at the time point at which the generation of the second response has been completed.

As described above, a response method in accordance with the present example embodiment is a response method that makes it possible to respond in natural language to a user with use of a language model trained by machine learning, the response method including: at least one processor carrying out a reception process of receiving an utterance of the user; the at least one processor carrying out a generation control process of causing the language model to generate a response to the utterance that has been received; and the at least one processor carrying out a presentation process of presenting, to the user, the response generated, in a case where the at least one processor receives a second utterance in a period from a time when a first utterance is received to a time when presentation of a first response to the first utterance is completed, the at least one processor starting generation of a second response based on the second utterance and presenting, to the user, the second response generated. With this configuration, the response method in accordance with the present example embodiment makes it possible to improve the responsiveness in an interaction using a language model.

### Second Example Embodiment

The following description will discuss a second example embodiment, which is an example embodiment of the present invention, in detail with reference to the drawings. Note that the scope of application of techniques which are employed in the present example embodiment is not limited to the present example embodiment. That is, techniques which are employed in the present example embodiment can be employed also in the other example embodiments included in the present disclosure, provided that no particular technical problem occurs. Moreover, techniques which are indicated in the drawings referred to for describing the present example embodiment can be employed also in the other example embodiments included in the present disclosure, provided that no particular technical problem occurs.

### (Configuration of Information Processing Apparatus 1A)

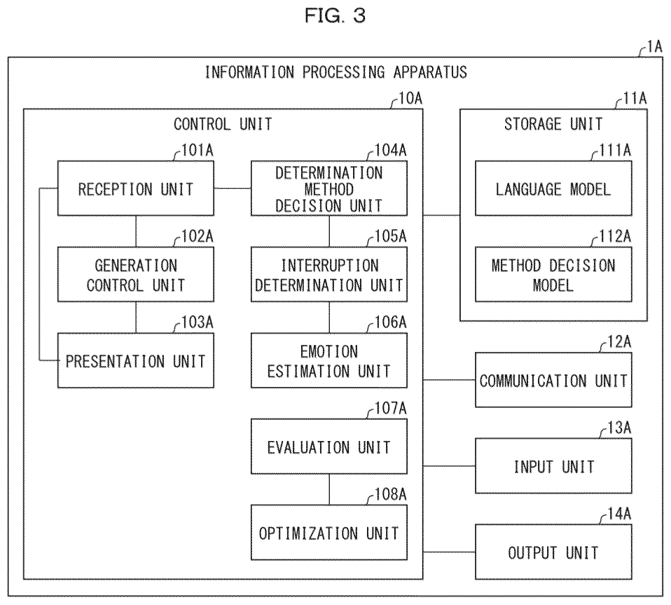

A configuration of an information processing apparatus 1A in accordance with the present example embodiment will be described with reference to FIG. 3. FIG. 3 is a block diagram illustrating the configuration of the information processing apparatus 1A. The information processing apparatus 1A makes it possible to respond in natural language to a user with use of a language model trained by machine learning. Note that the information processing apparatus 1A may be an apparatus whose main function is to respond to a user, or may be a general-purpose apparatus which includes other functions. The information processing apparatus 1A may be a stationary apparatus or a portable apparatus.

As illustrated in FIG. 3, the information processing apparatus 1A includes a control unit 10A that performs overall control of units of the information processing apparatus 1A and a storage unit 11A that stores various kinds of data to be used by the information processing apparatus 1A. The information processing apparatus 1A further includes a communication unit 12A that allows the information processing apparatus 1A to communicate with another apparatus, an input unit 13A that receives input to the information processing apparatus 1A, and an output unit 14A that allows the information processing apparatus 1A to output data. The control unit 10A includes a reception unit 101A, a generation control unit 102A, a presentation unit 103A, a determination method decision unit 104A, an interruption determination unit 105A, an emotion estimation unit 106A, an evaluation unit 107A, and an optimization unit 108A. Further, the storage unit 11A stores a language model 111A and a method decision model 112A. Note that details of the determination method decision unit 104A, the evaluation unit 107A, the optimization unit 108A, and the method decision model 112A will be described later.

The reception unit 101A receives an utterance of a user in the same manner as the reception unit 101 described in the first example embodiment. Further, the generation control unit 102A causes, in the same manner as the generation control unit 102 described in the first example embodiment, the language model 111A to generate a response to the utterance which has been received by the reception unit 101A. The language model 111A may be any model provided that the model is generated, in the same manner as the language model described in the first example embodiment, by machine learning so as to be capable of generating a response to an utterance of a user. Furthermore, the presentation unit 103A presents, in the same manner as the presentation unit 103 described in the first example embodiment, to the user, the response which has been generated under control of the generation control unit 102A.

In the information processing apparatus 1A, as in the information processing apparatus 1, in a case where the reception unit 101A receives a second utterance in a period from a time when a first utterance is received to a time when presentation of a first response to the first utterance is completed, the generation control unit 102A starts generation of a second response based on the second utterance. Then, the presentation unit 103 presents, to a user, the second response generated. This can provide an example advantage of making it possible to improve responsiveness in an interaction using the language model 111A, as in the case of the information processing apparatus 1.

In a case where a second utterance is received in a period from a time when a first utterance is received to a time when presentation of a first response to the first utterance is completed, the interruption determination unit 105A determines whether or not to start generation of a second response. Hereinafter, this determination is referred to as interruption determination. In a case where the interruption determination unit 105A determines to start generation of the second response, the generation control unit 102A causes the language model 111A to start generation of the second response, and the presentation unit 103A presents, to the user, the second response generated. On the other hand, in a case where the interruption determination unit 105A determines not to start generation of the second response, the generation control unit 102A does not cause the language model 111A to start generation of the second response. In this case, generation of the first response continues, and the presentation unit 103A presents, to the user, the first response generated.

The emotion estimation unit 106A estimates an emotion of the user in at least part of a period from a time when the first utterance ends to a time when the second utterance ends. The emotion estimation unit 106A may estimate the emotion of the user or may estimate whether or not the emotion of the user has changed. A result of estimation by the emotion estimation unit 106A is used for interruption determination by the interruption determination unit 105A.

### (Interruption Determination)

As described above, in a case where a second utterance is received in a period from a time when a first utterance is received to a time when presentation of a first response to the first utterance is completed, the interruption determination unit 105A determines whether or not to start generation of a second response.

The interruption determination unit 105A determines whether or not to start generation of the second response, on the basis of at least one selected from the group consisting of, for example, content of the second utterance, voice of the second utterance, an image obtained by capturing an image of a user in at least part of a period from a time when the first utterance ends to a time when the second utterance ends, and biological information of the user that is measured in at least part of the period from the time when the first utterance ends to the time when the second utterance ends. This configuration achieves, in addition to the example advantage yielded by the information processing apparatus 1, an example advantage of making it possible to realize a more natural interaction with a user. The following description will discuss interruption determination using various kinds of information as described above, with reference to a specific example.

### (Determination Based on Utterance Content)

For example, in a case where the interruption determination unit 105A determines, on the basis of content of a second utterance, whether or not to start generation of a second response, generation of the first response can be continued and the first response can be presented if the second utterance is simply a backchanneling response or an utterance having no particular meaning. In this way, a more natural interaction with the user is realized.

In interruption determination based on the content of the second utterance, the interruption determination unit 105A may determine whether or not to start generation of the second response, for example, depending on whether or not a predetermined word or phrase is included in the second utterance.

The predetermined word or phrase may be any of words or phrases (for example, “Yes”, “Ya”, “I see”, and “Well”) that are each like a simple sign of nodding or an utterance having no particular meaning and that each relatively frequently appear in utterances which are preferably not accepted as an interruption. In this case, if any of the above words or phrases is included in the second utterance, the interruption determination unit 105A does not cause the language model 111A to start generation of a second response.

Further, the predetermined word or phrase may be any of words or phrases (for example, “wait for a second”, “in other words”, “correctly”, and “incidentally”) that each relatively frequently appear in utterances which are preferably accepted as an interruption. In this case, if any of the above words or phrases is included in the second utterance, the interruption determination unit 105A causes the language model 111A to start generation of a second response.

### (Determination Based on Voice)

In a case where an interaction with a user is carried out by voice, it is also effective to determine, on the basis of voice of a second utterance, whether or not to start generation of a second response. This is because emotions and intentions of a user are reflected in voice.

The interruption determination unit 105A may perform determination in consideration of voice of a first utterance. Note that the determination based on the voice of the second utterance includes, in addition to determination directly using audio data of the second utterance, determination using a feature extracted from the audio data of the second utterance or determination using information that is obtained by analysis of the audio data. The same applies to determination based on an image, which will be described later.

In a case where it is determined, on the basis of the voice of the second utterance, whether or not to start generation of the second response, the interruption determination unit 105A may acquire, as the feature of the second utterance and from the audio data of the second utterance, at least one selected from the group consisting of pitch, volume, frequency, and speed. By defining in advance a relationship between a value of such a feature and whether or not to start generation of the second response, the interruption determination unit 105A can determine, on the basis of the value of the feature that is generated from the audio data which has been acquired, whether or not to start generation of the second response.

Further, the interruption determination unit 105A may acquire time-series data of the feature and determine, on the basis of a pattern of a time-series change of the feature, whether or not to start generation of the second response. For example, in a case where the second utterance is faster than the first utterance, the interruption determination unit 105A may determine to start generation of the second response. This is because, in such a case, it is considered that, after the first utterance, a user who has noticed an error or missing portion in the first utterance has immediately made the second utterance, an thus, it is preferable to accept the second utterance as an interruption.

### (Determination Based on Image)

In a case where it is possible to acquire an image obtained by capturing an image of a user in at least part of a period from a time when a first utterance ends to a time when a second utterance ends, it is also effective to determine, on the basis of the image, whether or not to start generation of a second response. This is because emotions and intentions of a user are reflected also in an image obtained by capturing an image of the user. Note that the image obtained may be a moving image or a still image.

In a case where it is determined, on the basis of an image as described above, whether or not to start generation of a second response, the interruption determination unit 105A may acquire a feature that indicates at least one selected from the group consisting of a line of sight of a user who is captured in an image acquired, a detection result of a facial landmark of the user, and a facial expression. In order to acquire the feature, it is possible to use, for example, a technique such as The Facial Action Coding System (FACS), OpenFace, Dlib, or the like. Then, by defining in advance a relationship between a value of the feature obtained from the image obtained by capturing an image of the user and whether or not to start generation of the second response, the interruption determination unit 105A can determine, on the basis of the feature that is generated from the image acquired, whether or not to start generation of the second response.

Further, the interruption determination unit 105A may acquire time-series data of the feature and determine, on the basis of a pattern of a time-series change of the feature, whether or not to start generation of the second response. For example, the interruption determination unit 105A may determine to start generation of the second response in a case where the value of the feature acquired indicates that the facial expression of the user has changed from a neutral expression to a negative expression (an expression of, for example, anger or disappointment).

Further, the interruption determination unit 105A may determine whether or not to start generation of the second response, depending on whether or not a predetermined action of the user is detected from a moving image obtained by capturing an image of the user or from time-series still images each obtained by capturing an image of the user. The predetermined action may be determined in advance. For example, the interruption determination unit 105A may determine to start generation of the second response, in a case where a gesture that requests to stop generation of the first response is detected.

### (Determination Based on Biological Information)

In case where it is possible to acquire biological information in at least part of a period from a time when a first utterance ends to a time when a second utterance ends, it is also effective to determine, on the basis of the biological information, whether or not to start generation of a second response. This is because emotions and intentions of the user are reflected also in biological information of the user. The biological information to be applied here may be any information that reflects emotions or the like of the user, and examples of the biological information include heart rate, pulse, and blood pressure.

In a case where it is determined, on the basis of biological information, whether or not to start generation of the second response, the interruption determination unit 105A may acquire the biological information, and directly use, as a feature, the biological information acquired or generate a feature from the biological information acquired. By defining in advance a relationship between (i) a value of the biological information acquired or a value of the feature generated from the biological information and (ii) whether or not to start generation of the second response, the interruption determination unit 105A can determine, on the basis of the biological information acquired, whether or not to start generation of the second response.

The interruption determination unit 105A may acquires time-series data of biological information. Then, the interruption determination unit 105A may determine whether or not to start generation of the second response, on the basis of a pattern of time-series change of the biological information or a pattern of time-series change of the feature generated from the biological information. For example, the interruption determination unit 105A may determine to start generation of the second response, in a case where the heart rate of the user increases in the period from the time when the first utterance ends to the time when the second utterance ends.

### (Determination by Combination of Plurality of Types of Features)

The interruption determination unit 105A may determine whether or not to start generation of a second response by combining a plurality of types of features. This configuration can increase determination accuracy in comparison with a case where determination is carried out only on the basis of one type of feature. For example, the interruption determination unit 105A may determine to start generation of the second response in a case where features acquired from an image of a user indicate that the facial expression of the user has negatively changed and the line of sight of the user has deviated. Alternatively, for example, the interruption determination unit 105A may determine to start generation of the second response in a case where the heart rate of a user increases and the speed at which the user utters increases.

### (Determination by Trained Model)

The interruption determination unit 105A may determine whether or not to start generation of a second response with use of a trained model that is trained to output, in response to input of data that indicates content of an utterance, a result of determination as to whether or not to start generation of a response. In this case, the interruption determination unit 105A determines, on the basis of an output which is obtained by inputting a second utterance to the trained model, whether or not to start generation of the second response.

As the trained model, for example, the language model 111A that is used for generation of a response can be used. In a case where the language model 111A is used, the interruption determination unit 105A generates a prompt that includes text data of the second utterance and that asks whether or not that utterance is requesting a response. Then, the interruption determination unit 105A may input the prompt to the language model 111A. In this case, if the output of the language model 111A indicates that a response is requested, the interruption determination unit 105A cause the language model 111A to start generation of the second response. On the other hand, the interruption determination unit 105A does not cause the language model 111A to start generation of the second response in a case where the output of the language model 111A indicates that no response is requested. The interruption determination unit 105A may also include, in the prompt described above, text data of a first utterance. This configuration can achieve more accurate interruption determination in consideration of a flow of utterance from the first utterance to the second utterance.

Moreover, the trained model to be used for interruption determination may be a model which has been trained for interruption determination. Such a trained model can be generated as a result of machine learning using training data in which each of various types of data that are used as determination materials for determining whether or not to accept a second utterance as an interruption is associated with whether or not to receive a second utterance as an interruption, that is, correct answer data.

Data that serves as a determination material as to whether or not to accept the second utterance as an interruption may be, for example, text data and/or audio data of the second utterance or a feature that is generated from such data. The above data serving as a determination material may be an image obtained by capturing an image of a user in at least part of a period from a time when the first utterance ends to a time when the second utterance ends, biological information of the user that is measured in that period, or a feature generated from data of the image or the biological information.

### (Determination Based on Result of Estimation of Emotion)

The information processing apparatus 1A includes an emotion estimation unit 106A that estimates an emotion of a user in at least part of a period from a time when a first utterance ends to a time when a second utterance ends. Therefore, the interruption determination unit 105A may determine whether or not to start generation of a second response, on the basis of a result of estimation by the emotion estimation unit 106A. This configuration achieves, in addition to the example advantage yielded by the information processing apparatus 1, an example advantage of making it possible to realize a natural interaction in consideration of the emotion of the user.

Note that as described above, the emotion estimation unit 106A may estimate the emotion of the user or may estimate whether or not the emotion of the user has changed. Further, the emotion estimation unit 106A may use any estimation method. For example, the emotion estimation unit 106A may determine, with use of an emotion polarity dictionary which indicates a positive degree and a negative degree of each of various words and phrases, the positive degree and the negative degree of each of words and phrases that are included in the second utterance. Then, the emotion estimation unit 106A may put results of such determination together and determine the positive degree or negative degree of the second utterance. In this case, the interruption determination unit 105A may determine to start generation of the second response in a case where the positive degree of the second utterance is equal to or less than a threshold or the negative degree of the second utterance is equal to or more than the threshold.

The estimation emotion unit 106A may estimate, with use of the language model 111A, the emotion of the user at a time when the second utterance is made. In this case, the emotion estimation unit 106A may generate a prompt that includes the second utterance and that instructs estimation of an emotion of one who utters, and then input the prompt to the language model 111A. As a result, a result of estimation of the emotion of the one who utters is outputted from the language model 111A. Note that a language model to be used for emotion estimation may be a language model other than the language model 111A (for example, a language model that has been fine-tuned for emotion estimation).

Further, the emotion estimation unit 106A may estimate the emotion on the basis of at least one selected from the group consisting of content of the second utterance, voice of the second utterance, an image obtained by capturing an image of the user in at least part of the period from the time when the first utterance ends to the time when the second utterance ends, and biological information that is measured in that period. The emotion can be estimated by comparing each of the above-described various kinds of data or a feature that is obtained from each of the various kinds of data with a predetermined threshold. Alternatively, the emotion can be estimated with use of a trained model that has been trained to learn a relationship between the feature and the emotion.

Note that it can be said that in a case where whether or not to start generation of the second response is determined on the basis of a result of estimation as described above, the interruption determination unit 105A determines whether or not to start generation of the second response on the basis of at least one selected from the group consisting of content of the second utterance, voice of the second utterance, an image obtained by capturing an image of the user in at least part of the period from the time when the first utterance ends to the time when the second utterance ends, and biological information of the user that is measured in at least part of that period.

### (Use of Plurality of Interruption Determination Methods)

As described above, various interruption determination methods (hereinafter, simply referred to as “interruption determination methods”) can be applied. The interruption determination methods include methods whose characteristics are different from each other, such as a method which takes a long time to obtain a determination result but which has a high determination accuracy, a method which quickly provides a determination result but which has a relatively low determination accuracy, etc. Therefore, the interruption determination unit 105A may make a determination by applying an interruption determination method in accordance with a user among the plurality of interruption determination methods each for determining whether or not to start generation of a second response. This configuration achieves, in addition to the example advantage yielded by the information processing apparatus 1, an example advantage of making it possible to decide an appropriate interruption determination method in accordance with a user.

Which interruption determination method is to be applied may be decided by the determination method decision unit 104A. For example, the determination method decision unit 104A may allow a user to select in advance which interruption determination method is to be applied. In this case, the interruption determination method which the user has selected in advance is applied. Alternatively, for example, the determination method decision unit 104A may allow a preference of the user with regard to an interaction to be inputted in advance. In this case, it is decided to apply an interruption determination method in accordance with the preference of the user. For example, the determination method decision unit 104A may decide, for a user who puts importance on response speed in an interaction, to apply an interruption determination method that takes a relatively short time to obtain a determination result.

Alternatively, for example, the determination method decision unit 104A may cause a user to make trials of respective interactions to which various interruption determination methods are applied. In this case, the determination method decision unit 104A may allow the user to select which interruption determination method is to be applied after the trials. Alternatively, the determination method decision unit 104A may cause the evaluation unit 107A to evaluate the various interruption determination methods on the basis of trial results of the various interruption determination methods. In this case, the determination method decision unit 104A may determine to apply the interruption determination method whose result of evaluation was the best.

### (Details of Determination Method Decision Unit 104A/Evaluation Unit 107A/Optimization Unit 108A)

The following description will discuss the determination method decision unit 104A, the evaluation unit 107A, and the optimization unit 108A in detail. Further, details of the method decision model 112A will be also described below.

The determination method decision unit 104A determines an interruption determination method which is to be applied by the interruption determination method 105A. Various methods can be applied as a method of deciding the interruption determination method. For example, as described above, the determination method decision unit 104A can also decide, on the basis of selection of a user, the interruption determination method to be applied.

The determination method decision unit 104A can also decide the interruption determination method, with use of the method decision model 112A. The method decision model 112A is a model for deciding the interruption determination method to be applied. For example, the method decision model 112A may be a trained model which has been generated by machine learning of a correspondence relationship between various kinds of information which are preferably taken into account in deciding an optimum interruption determination method and an optimum interruption determination method which corresponds to the information. Alternatively, for example, the method decision model 112A may be a model that has been generated by reinforcement learning.

Alternatively, for example, the method decision model 112A may be an optimization model that determines the optimum interruption determination method in accordance with a given condition. In a case where the method decision model 112A is an optimization model, the optimization unit 108A repeatedly updates the method decision model 112A as described later, and thus optimizes the method decision model 112A.

The language model 111A can also be used as the method decision model 112A. In this case, the determination method decision unit 104A may generate a prompt that includes a list of candidate interruption determination methods and a description of a subject case and that instructs selection of an interruption determination method which is suitable for the subject case from among the candidate interruption determination methods. Then, the determination method decision unit 104A may input the prompt to the language model 111A. This configuration makes it possible to obtain, from the language model 111A, an output that indicates the interruption determination method which is suitable for the subject case. Note that it is preferable to include, in the list of candidate interruption determination methods, explanations of: features of the interruption determination methods; what kind of user each interruption determination method is suited to; and the like. It is preferable to include, in the description of the subject case, attribute information (e.g., age, gender, occupation, personality, etc.) of a user, a second utterance that is to be subjected to interruption determination, and a first utterance preceding the second utterance, and the like.

The evaluation unit 107A evaluates the interruption determination method that has been applied by the interruption determination unit 105A. A method of such evaluation is not particularly limited. For example, the evaluation unit 107A may receive feedback from a user with regard to an interaction to which the interruption determination method that is subject of evaluation is applied or with regard to a response which is presented in the interaction. Then, the evaluation unit 107A may use the feedback as a result of evaluation on the interruption determination method.

The feedback that the evaluation unit 107A receives may be feedback that is explicitly made by the user, such as feedback in language or feedback via the communication unit 12A or the input unit 13A. In this case, the evaluation unit 107A may use, as the result of evaluation on the interruption determination method, inputted feedback as is.

The evaluation unit 107A may receive, as the feedback, at least one selected from the group consisting of text that indicates content of an utterance of the user during the interaction and after the interaction, utterance voice, an image, biological information, and the like. In this case, the evaluation unit 107A may generate a result of evaluation, by analyzing the at least one selected from the group consisting of the text that indicates the content of the utterance of the user, the utterance voice, the image, the biological information, and the like. Evaluation criteria may be determined in advance. For example, in a case where a facial expression or voice of a user which is detected during an interaction (especially, at a time when the second response to the second utterance is presented) is calm, the result of evaluation by the evaluation unit 107A on the interruption determination method applied may be “good”. On the other hand, in a case where the facial expression or voice of the user which is detected is displeased or which indicates discontentment, the result of evaluation by the evaluation unit 107A on the interruption determination method applied may be “not good”.

The result of evaluation by the evaluation unit 107A can be used to change the interruption determination method to be applied. That is, the determination method decision unit 104A may decide an interruption determination method to be applied in next and subsequent interruption determinations, on the basis of the result of evaluation by the evaluation unit 107A on the interruption determination method that was applied by the interruption determination unit 105A. This configuration achieves, in addition to the example advantage yielded by the information processing apparatus 1, an example advantage of making it possible to automatically apply an interruption determination method with which a response presented to a user is more preferable.

The result of evaluation by the evaluation unit 107A can be used for optimization of the method decision model 112A. The optimization unit 108A optimizes the method decision model 112A on the basis of the result of evaluation by the evaluation unit 107A. More specifically, the optimization unit 108A may optimize the method decision model 112A, by carrying out, for each interruption determination method that has been decided with use of the method decision model 112A, a process of updating the method decision model 112A on the basis of the result of evaluation on the interruption determination method which has been decided. This configuration achieves, in addition to the example advantage yielded by the information processing apparatus 1, an example advantage of making it possible to optimize the method decision model 112A while the interruption determination method is repeatedly decided with use of the method decision model 112A. For example, the optimization unit 108A can also optimize the method decision model 112A by applying a technique that is called on-line optimization.

### (Example of Interaction in Text)

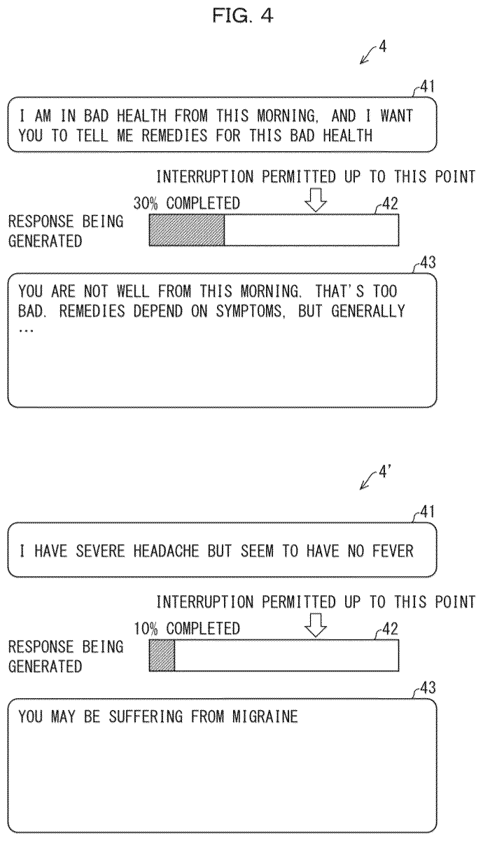

FIG. 4 is a diagram illustrating an example of an interaction in text between the information processing apparatus 1A and a user of the information processing apparatus 1A. The interaction in text is carried out via a user interface (UI) screen which is displayed on an arbitrary display apparatus. FIG. 4 illustrates an example UI screen 4 in a period from a time when input of a first utterance is received to a time when a second utterance is inputted, and an example UI screen 4′ after a time when input of the second utterance is received. These example UI screens each include an input field 41 and a response display field 43, and each also display progress information 42 that indicates progress of generation of a response.

The input field 41 is a display object for receiving text that is inputted by a user, that is, an utterance of the user. The input field 41 is also a display object for displaying text that is inputted by the user. In other words, the reception unit 101A receives, as an utterance of the user, the text that is inputted in the input field 41. Then, the presentation unit 103A causes the input field 41 to display the text inputted.

For example, in the input field 41 of the example UI screen 4, text “I am in bad health from this morning, and I want you to tell me remedies for this bad health” is displayed. This is the text of a first utterance which has been inputted by the user. The generation control unit 102A inputs this text to the language model 111A and generates a response to this text. The response thus generated is displayed in the response display field 43 by the presentation unit 103A. In the example UI screen 4, the presentation unit 103A displays, in order from a generated portion, a response that is generated under control of the generation control unit 102A.

Further, in the UI screen example 4, the presentation unit 103A displays a progress bar as the progress information 42 that indicates a state of progress of generation of the response. The progress bar in the example UI screen 4 indicates a state of progress of generation of the first response. In this indication, a progress percentage at a time point at which the generation of the first response is started is set to 0% and the progress percentage at a time point at which the generation is completed is set to 100%.

Further, in the UI screen example 4, an arrow that indicates a threshold of the progress percentage is displayed in association with the progress bar. The threshold of the progress percentage is a threshold that is used for determination on whether or not to accept an interruption. More specifically, the generation control unit 102A causes the language model 111A to generate a second response, on the condition that at a time when the second utterance is received, the progress percentage of generation of the first response is less than a predetermined threshold.

On the other hand, in the input field 41 of the example UI screen 4′, text “I have severe headache but seem to have no fever” is displayed. This is text of the second utterance which the user has inputted while the progress percentage of generation of the first response is less than the threshold. In the example of FIG. 4, in the UI screen example 4, the first response that is generated is displayed in order from a generated portion. Accordingly, in a case where the content of the first response displayed is not intended content, the user can enter text of the second utterance as described above before generation and presentation of the first response is completed.

In a case where the text of the second utterance is entered in a period in which the progress percentage of generation of the first response is less than the threshold (for example, the progress percentage is 30% as in the UI screen example 4), the generation control unit 102A starts generation of the second response based on the text of the second utterance, and the presentation unit 103 presents, to the user, the second response generated.

In the response display field 43 of the example UI screen 4′, a new response, that is, the second response, which is generated in consideration of a symptom of the user that has been added in the second utterance is displayed. Further, in the UI screen example 4′, the display of the progress bar is also updated to show the progress percentage of the second response in response to the second utterance. In this way, the information processing apparatus 1A can quickly present a response that the user desires. Further, as in the example of FIG. 4, the information processing apparatus 1A can be used in the fields of medicine and healthcare.

As described above, with use of the information processing apparatus 1A, a user can receive presentation of a response in consideration of content of each utterance, even in a case where the user makes an utterance (input of text) in a row. Note that in a case where a third utterance is received while the progress percentage of the second response is less than the threshold, the information processing apparatus 1A starts generation and presentation of a response to the third utterance. In this way, the information processing apparatus 1A can also deal with a plurality of interruptions.

Further, as described above, the presentation unit 103A may present, to a user, progress information that indicates the state of progress of generation of the first response in a period from a time when the first utterance is received to a time when presentation of the first response to the first utterance is completed. This configuration achieves, in addition to the example advantage yielded by the information processing apparatus 1, an example advantage of making it possible to allow a user to determine whether or not to make a second utterance in consideration of the state of progress of generation of the first response. Note that the progress information need only be information that indicates the state of progress of generation of the first response. Presentation of the progress information is not limited to presentation with use of the progress bar. For example, the presentation unit 103A may present, as the progress information, a numerical value or the like that indicates the state of progress of generation of the first response.

Further, as described above, the generation control unit 102A may cause the language model 111A to generate the second response, on the condition that at a time when the second utterance is received, the progress percentage of generation of the first response is less than the predetermined threshold. In this case, the presentation unit 103A may present, to the user, the threshold and the progress information that indicates the progress percentage of generation of the first response. This configuration achieves, in addition to the example advantage yielded by the information processing apparatus 1, an example advantage of making it possible for a user to determine, in consideration of the state of progress of generation of the first response and an end of a period in which interruption is possible, whether or not to make a second utterance or timing of making a second utterance.

(Example of Interaction with Sound)

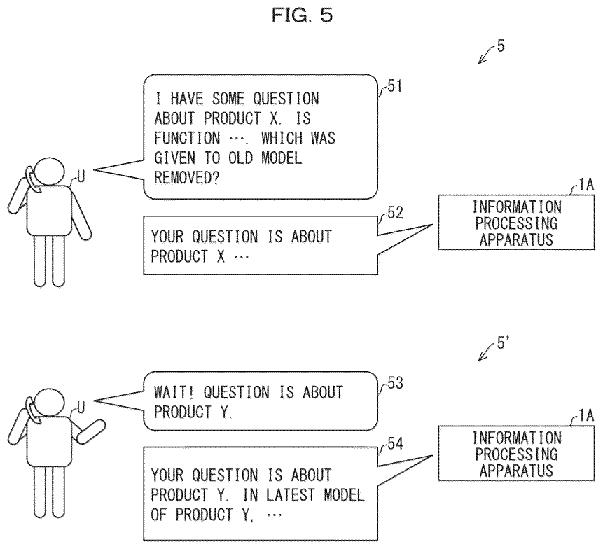

FIG. 5 is a diagram illustrating an example of an interaction with sound between the information processing apparatus 1A and a user of the information processing apparatus 1A. The interaction with sound is carried out via an audio input apparatus that acquires voice that is uttered by a user and an audio output apparatus that outputs sound for a response to the user. In the example of FIG. 5, the information processing apparatus 1A and a user U interact with each other via an audio input apparatus and an audio output apparatus which are included in a telephone. In this way, the information processing apparatus 1A can be used also for an automatic response to an inquiry through a telephone. Note that FIG. 5 illustrates, with use of an utterance bubble associated with the information processing apparatus 1A, content of an utterance that is outputted from the information processing apparatus 1A. In practice, however, audio of utterance that is outputted from the information processing apparatus 1A is outputted from an audio output apparatus of a receiver.

In a scene 5 illustrated in FIG. 5, as shown in an utterance bubble 51, the user U asks a question about “Product X”. The reception unit 101A of the information processing apparatus 1A receives, as a first utterance, audio data of the question and converts the audio data into text data. Then, the generation control unit 102A inputs, to the language model 111A, the text data of the first utterance and causes the language model 111A to generate a first response. The presentation unit 103A causes the audio output apparatus that is provided in the telephone to make an audio output of the first response generated. FIG. 5 illustrates, with use of an utterance bubble 52, the first response that has been outputted. At a time point of the scene 5, generation and presentation of the first response is not completed, and only a first part of the first response is presented.

FIG. 5 shows, as a scene 5′, a scene in which before generation and presentation of the first response is completed, the user U makes a second utterance and a response to the second utterance is presented. Specifically, the user U makes a second utterance which tells, as shown in an utterance bubble 53, that the previous question was not a question about “Product X” but about “Product Y”.

The above second utterance is received in a period from a time when the reception unit 101A receives the first utterance to a time when presentation of the first response to the first utterance is completed. For this reason, the generation control unit 102A starts generation of a second response based on the second utterance. Then, the presentation unit 103 presents, to the user U, the second response generated. The second response is made, as shown in an utterance bubble 54, in response to a question in which “Product X” in the first question shown in the utterance bubble 51 is corrected to “Product Y” on the basis of the second utterance. Such a second response can be generated by inputting both of the first and second utterances to the language model 111A.

In this way, use of the information processing apparatus 1A allows the user U to, by making the second utterance for correcting an error in the first utterance at the time when the user U recognizes the error in the first utterance, receive presentation of the second response to the question in which correction is reflected.

### (Process Flow)

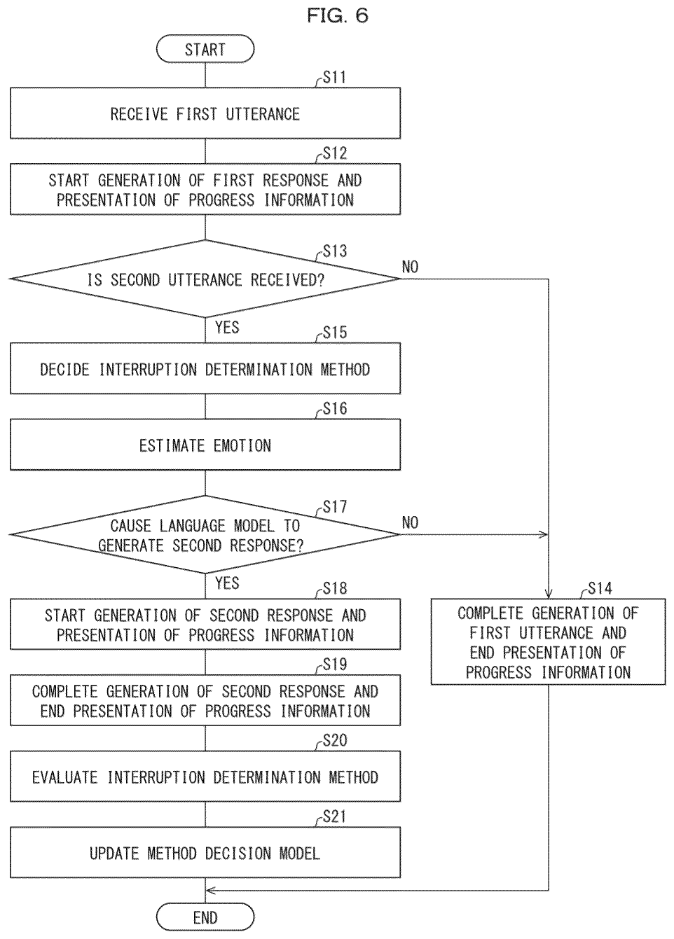

The following will discuss a flow of a series of processes which is carried out by the information processing apparatus 1A, with reference to FIG. 6. FIG. 6 is a flowchart illustrating the flow of the series of processes which is carried out by the information processing apparatus 1A. The flowchart of FIG. 6 includes steps of the response method in accordance with the present example embodiment.

In S11 (reception process), the reception unit 101A receives input of a first utterance made by a user. As described above, such an utterance may be made by input of audio data or may be made by input of text data. Further, the reception unit 101A may convert the audio data into text data, in a case where input of the audio data of the first utterance is received.

In S12 (generation control process), the generation control unit 102A causes the language model 111A to start generation of a first response to the first utterance which has been received in S11. Further, in S12, the presentation unit 103A starts presentation of progress information that indicates a state of progress of generation of the first response. Moreover, after starting presentation of the progress information, the presentation unit 103A updates content of the progress information presented, in accordance with the progress of generation of the first response.

Further, the presentation unit 103A may present, in order from a portion generated, the first response that has been generated under control of the generation control unit 102A (presentation process). Note that the presentation unit 103A may omit presentation of the progress information in a case where the response is presented in sound. These matters are similarly applied to a process of S18, which will be described later.

In S13, the reception unit 101A determines whether or not a second utterance made by the user has been received. In a case where a result of determination above is YES in S13, the reception unit 101A carries out a reception process of the second utterance and the series of processes proceeds to S15. On the other hand, in a case where the result of determination is NO in S13, the series of processes proceeds to S14.

In regard to the process of S13, the reception unit 101A only needs to be waiting for the second utterance in a period from a time when the first utterance is received to a time when presentation of the first response to the first utterance is completed. Moreover, in the above period, the reception unit 101A may wait for the second utterance in a period in which the progress percentage of generation of the first response is less than a predetermined threshold. Note that it is possible to determine, in S17, whether or not the progress percentage of generation of the first response is less than the predetermined threshold.

In S14, the generation control unit 102A completes generation of the first response, and thus the first response, generation of which has been completed, is presented to the user by the presentation unit 103A (presentation process). Further, the presentation unit 103A ends presentation of the progress information on the first response. With this presentation, the series of processes in FIG. 6 ends. Note that, in a case where the response is presented in sound, both generation and presentation of the first response are completed in S14. This also applies to S19 which will be described later.

In S15, the determination method decision unit 104A decides the interruption determination method. More specifically, the determination method decision unit 104A inputs predetermined input data (for example, text data of a second utterance) to the method decision model 112A. Then, the determination method decision unit 104A decides the interruption determination method on the basis of output data of the method decision model 112A.

In S16, the emotion estimation unit 106A estimates an emotion of the user. More specifically, the emotion estimation unit 106A estimates the emotion to be considered in the interruption determination method that has been decided in S15. For example, assume a case in which the interruption determination method decided in S15 uses the positive degree and the negative degree of the emotion of the user at the time of making the first utterance and at the time of making the second utterance. In this case, the emotion estimation unit 106A estimates the positive degree and the negative degree of the emotion of the user at each of the time of making the first utterance and the time of making the second utterance. Note that in a case where a result of estimation of the emotion is not used in the interruption determination method decided in S15, a process of S16 is omitted.

In S17, the interruption determination unit 105A determines, by applying the interruption determination method that has been decided in S15, whether or not to cause the language model 111A to generate a second response on the basis of the result of estimation of the emotion in S16. In a case where a result of determination above is YES in S17, the series of processes proceeds to S18. On the other hand, in a case where the result of determination above is NO in S17, the series of processes proceeds to S14.

In S18 (generation control process), the generation control unit 102A causes the language model 111A to start generation of the second response to the second utterance. In this case, the generation control unit 102A may stop generation of the first response. Further, in S18, the presentation unit 103A starts presentation of progress information that indicates a state of progress of generation of the second response.

In S19, the generation control unit 102A completes generation of the second response, and thus the second response, generation of which has been completed, is presented to the user by the presentation unit 103A (presentation process). Further, the presentation unit 103A ends presentation of the progress information on the second response. Note that in a case where generation of the first response has been continued, the presentation unit 103A may present the first response as well.

In S20, the evaluation unit 107A evaluates the interruption determination method that has been decided in S15. In S21, the optimization unit 108A updates the method decision model 112A on the basis of a result of evaluation in S20. With this update, the series of processes in FIG. 6 ends. Note that after completion of S14, S19, or S21, the series of processes may return to the process of S11, and further input of an utterance may be received. The processes of S20 and S21 may be carried out after the end of interaction.

### [Software Implementation Example]

Some or all of the functions of the information processing apparatuses 1 and 1A can be realized by hardware such as an integrated circuit (IC chip), or can be realized by software.

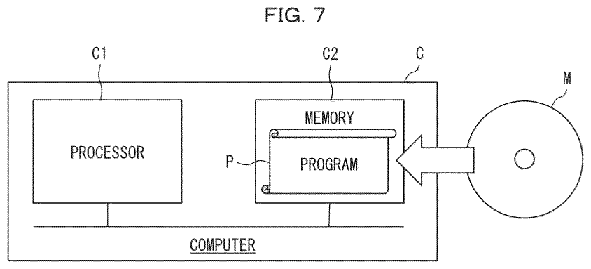

In the latter case, the information processing apparatuses 1 and 1A are each realized by, for example, a computer that executes instructions of a program that is software realizing the foregoing functions. FIG. 7 illustrates an example of such a computer (hereinafter referred to as “computer C”). FIG. 7 is a block diagram illustrating a hardware configuration of the computer C which functions as the information processing apparatus 1 or 1A.

The computer C includes at least one processor C1 and at least one memory C2. In the memory C2, a program (response program) P for causing the computer C to operate as the information processing apparatus 1 or 1A is recorded. In the computer C, the functions of the information processing apparatus 1 or 1A are realized by the processor C1 reading the program P from the memory C2 and executing the program P.

Examples of the processor C1 encompass a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, and a combination thereof. Examples of the memory C2 include a flash memory, a hard disk drive (HDD), a solid state drive (SSD), and a combination thereof.

Note that the computer C may further include a random access memory (RAM) in which the program P is loaded during execution of the program P and/or in which various kinds of data are temporarily stored. The computer C may further include a communication interface via which the computer C transmits and receives data to and from another apparatus. The computer C may further include an input/output interface via which the computer C is connected to an input/output apparatus(es) such as a keyboard, a mouse, a display, and/or a printer.

The program P can be stored in a non-transitory tangible storage medium M which is readable by the computer C. Examples of the storage medium M encompass a tape, a disk, a card, a semiconductor memory, and a programmable logic circuit. The computer C can acquire the program P via the storage medium M. The program P can be transmitted via a transmission medium. Examples of the transmission medium encompass a communications network and a broadcast wave. The computer C can acquire the program P also via such a transmission medium.

The foregoing functions of the information processing apparatuses 1 and 1A may be realized by a single processor provided in a single computer, may be realized by cooperation by a plurality of processors provided in a single computer, or may be realized by cooperation by a plurality of processors provided in a respective plurality of computers. A program for causing the information processing apparatus 1 or 1A to realize the foregoing functions may be stored in a single memory provided in a single computer, may be stored dispersedly in a plurality of memories provided in a single computer, or may be stored dispersedly in a plurality of memories provided in a respective plurality of computers.

### [Additional Remarks]

The present disclosure includes techniques described in supplementary notes below. Note, however, that the present invention is not limited to the techniques described in the supplementary notes below, but may be altered in various ways by a skilled person within the scope of the claims.

### [Additional Remark A]

### (Supplementary Note A1)

An information processing apparatus that makes it possible to respond in natural language to a user with use of a language model trained by machine learning, the information processing apparatus including: a reception means that receives an utterance of the user; generation control means that causes the language model to generate a response to the utterance that has been received; and a presentation means that presents, to the user, the response generated, in a case where the reception means receives a second utterance in a period from a time when a first utterance is received to a time when presentation of a first response to the first utterance is completed, the generation control means starting generation of a second response based on the second utterance and the presentation means presenting, to the user, the second response generated.

### (Supplementary Note A2)

The information processing apparatus according to supplementary note A1, wherein the presentation means presents, to the user, progress information that indicates a state of progress of generation of the first response, in the period from the time when the first utterance is received to the time when presentation of the first response to the first utterance is completed.

### (Supplementary Note A3)

The information processing apparatus according to supplementary note A2, wherein: the generation control means causes the language model to generate the second response, on a condition that at a time when the second utterance is received, a progress percentage of generation of the first response is less than a predetermined threshold; and the presentation means presents, to the user, the predetermined threshold and the progress information that indicates the progress percentage of generation of the first response.

### (Supplementary Note A4)

The information processing apparatus according to any one of supplementary notes A1 to A3, further including an interruption determination means that determines whether or not to start generation of the second response, on the basis of at least one selected from the group consisting of content of the second utterance, voice of the second utterance, an image obtained by capturing an image of the user in at least part of a period from a time when the first utterance ends to a time when the second utterance ends, and biological information of the user that is measured in at least part of the period from the time when the first utterance ends to the time when the second utterance ends.

### (Supplementary Note A5)

The information processing apparatus according to supplementary note A4, wherein the interruption determination means determines whether or not to start generation of the second response, by applying an interruption determination method in accordance with the user among a plurality of interruption determination methods for determining whether or not to start generation of the second response.

### (Supplementary Note A6)

The information processing apparatus according to supplementary note A4 or A5, further including a determination method decision means that decides an interruption determination method to be applied in next and subsequent interruption determinations, on the basis of a result of evaluation on the interruption determination method that was applied by the interruption determination means.

### (Supplementary Note A7)

The information processing apparatus according to supplementary note A4 or A5, further including an optimization means that optimizes a method decision model for deciding an interruption determination method that is applied by the interruption determination means, the optimization means optimizing the method decision model by carrying out, for each interruption determination method that has been decided with use of the method decision model, a process of updating the method decision model on the basis of a result of evaluation on the interruption determination method that has been decided.

### (Supplementary Note A8)

The information processing apparatus according to any one of supplementary notes A1 to A3, further including: an emotion estimation means that estimates an emotion of the user in at least part of a period from a time when the first utterance ends to a time when the second utterance ends; and an interruption determination means that determines, on the basis of a result of estimation by the emotion estimation means, whether or not to start generation of the second response.

### [Additional Remark B]

### (Supplementary Note B1)

A response method that makes it possible to respond in natural language to a user with use of a language model trained by machine learning, the response method including: at least one processor carrying out a reception process of receiving an utterance of the user; the at least one processor carrying out a generation control process of causing the language model to generate a response to the utterance that has been received; and the at least one processor carrying out a presentation process of presenting, to the user, the response generated, in a case where the at least one processor receives a second utterance in a period from a time when a first utterance is received to a time when presentation of a first response to the first utterance is completed, the at least one processor starting generation of a second response based on the second utterance and presenting, to the user, the second response generated.

### (Supplementary Note B2)

The response method according to supplementary note B1, wherein the at least one processor presents, to the user, progress information that indicates a state of progress of generation of the first response, in the period from the time when the first utterance is received to the time when presentation of the first response to the first utterance is completed.

### (Supplementary Note B3)

The response method according to supplementary note B2, wherein: in the generation control process, the at least one processor causes the language model to generate the second response, on a condition that at a time when the second utterance is received, a progress percentage of generation of the first response is less than a predetermined threshold; and the at least one processor presents, to the user, the predetermined threshold and the progress information that indicates the progress percentage of generation of the first response.

### (Supplementary Note B4)

The response method according to any one of supplementary notes B1 to B3, further including the at least one processor carrying out an interruption determination process of determining whether or not to start generation of the second response, on the basis of at least one selected from the group consisting of content of the second utterance, voice of the second utterance, an image obtained by capturing an image of the user in at least part of a period from a time when the first utterance ends to a time when the second utterance ends, and biological information of the user that is measured in at least part of the period from the time when the first utterance ends to the time when the second utterance ends.

### (Supplementary Note B5)

The response method according to supplementary note B4, wherein in the interruption determination process, the at least one processor determines whether or not to start generation of the second response, by applying an interruption determination method in accordance with the user among a plurality of interruption determination methods for determining whether or not to start generation of the second response.

### (Supplementary Note B6)

The response method according to supplementary note B4 or B5, further including the at least one processor carrying out a determination method decision process of deciding an interruption determination method to be applied in next and subsequent interruption determination processes, on the basis of a result of evaluation on the interruption determination method that was applied.

### (Supplementary Note B7)

The response method according to supplementary note B4 or B5, wherein: an interruption determination method that is applied in the interruption determination process has been determined with use of a method decision model for deciding the interruption determination method; and the at least one processor optimizes the method decision model by carrying out, for each interruption determination method that has been decided with use of the method decision model, a process of updating the method decision model on the basis of a result of evaluation on the interruption determination method that has been decided.

### (Supplementary Note B8)

The response method according to any one of supplementary notes B1 to B3, further including: the at least one processor carrying out an emotion estimation process of estimating an emotion of the user in at least part of a period from a time when the first utterance ends to a time when the second utterance ends; and the at least one processor carrying out an interruption determination process of determining, on the basis of a result of estimation in the emotion estimation process, whether or not to start generation of the second response.

### [Additional Remark C]

### (Supplementary Note C1)

A response program that makes it possible to respond in natural language to a user with use of a language model trained by machine learning, the response program causing a computer to function as: a reception means that receives an utterance of the user; a generation control means that causes the language model to generate a response to the utterance that has been received; and a presentation means that presents, to the user, the response generated, in a case where the reception means receives a second utterance in a period from a time when a first utterance is received to a time when presentation of a first response to the first utterance is completed, the generation control means starting generation of a second response based on the second utterance and the presentation means presenting, to the user, the second response generated.

### (Supplementary Note C2)

The response program according to supplementary note C1, wherein the presentation means presents, to the user, progress information that indicates a state of progress of generation of the first response, in the period from the time when the first utterance is received to the time when presentation of the first response to the first utterance is completed.

### (Supplementary Note C3)

The response program according to supplementary note C2, wherein: the generation control means causes the language model to generate the second response, on a condition that at a time when the second utterance is received, a progress percentage of generation of the first response is less than a predetermined threshold; and the presentation means presents, to the user, the predetermined threshold and the progress information that indicates the progress percentage of generation of the first response.

### (Supplementary Note C4)

The response program according to any one of supplementary notes C1 to C3, causing the computer to further function as an interruption determination means that determines whether or not to start generation of the second response, on the basis of at least one selected from the group consisting of content of the second utterance, voice of the second utterance, an image obtained by capturing an image of the user in at least part of a period from a time when the first utterance ends to a time when the second utterance ends, and biological information of the user that is measured in at least part of the period from the time when the first utterance ends to the time when the second utterance ends.

### (Supplementary Note C5)

The response program according to supplementary note C4, wherein the interruption determination means determines whether or not to start generation of the second response, by applying an interruption determination method in accordance with the user among a plurality of interruption determination methods for determining whether or not to start generation of the second response.

### (Supplementary Note C6)

The response program according to supplementary note C4 or C5, causing the computer to further function as the determination method decision means that decides an interruption determination method to be applied in next and subsequent interruption determinations, on the basis of a result of evaluation on the interruption determination method that was applied by the interruption determination means.

### (Supplementary Note C7)

The response program according to supplementary note C4 or C5, causing the computer to further function as an optimization means that optimizes a method decision model for deciding an interruption determination method that is applied by the interruption determination means, the optimization means optimizing the method decision model by carrying out, for each interruption determination method that has been decided with use of the method decision model, a process of updating the method decision model on the basis of a result of evaluation on the interruption determination method that has been decided.

### (Supplementary Note C8)

The response program according to any one of supplementary notes C1 to C3, for causing the computer to further function as: an emotion estimation means that estimates an emotion of the user in at least part of a period from a time when the first utterance ends to a time when the second utterance ends; and an interruption determination means that determines, on the basis of a result of estimation by the emotion estimation means, whether or not to start generation of the second response.

### [Additional Remark D]

### (Supplementary Note D1)

An information processing apparatus that makes it possible to respond in natural language to a user with use of a language model trained by machine learning, the information processing apparatus including at least one processor, the at least one processor carrying out: a reception process of receiving an utterance of the user; a generation control process of causing the language model to generate a response to the utterance that has been received; and a presentation process of presenting, to the user, the response generated, in a case where the at least one processor receives a second utterance in a period from a time when a first utterance is received to a time when presentation of a first response to the first utterance is completed, the at least one processor starting generation of a second response based on the second utterance and presenting, to the user, the second response generated.

It should be noted that the information processing apparatus may further include a memory. Further, the memory may store a program for causing the at least one processor to carry out each of the above-described processes.

### (Supplementary Note D2)

The information processing apparatus according to supplementary note D1, wherein the at least one processor presents, to the user, progress information that indicates a state of progress of generation of the first response, in the period from the time when the first utterance is received to the time when presentation of the first response to the first utterance is completed.

### (Supplementary Note D3)

The information processing apparatus according to supplementary note D2, wherein: in the generation control process, the at least one processor causes the language model to generate the second response, on a condition that at a time when the second utterance is received, a progress percentage of generation of the first response is less than a predetermined threshold; and the at least one processor presents, to the user, the predetermined threshold and the progress information that indicates the progress percentage of generation of the first response, during generation of the first response.

### (Supplementary Note D4)

The information processing apparatus according to any one of supplementary notes D1 to D3, wherein the at least one processor carries out an interruption determination process of determining whether or not to start generation of the second response, on the basis of at least one selected from the group consisting of content of the second utterance, voice of the second utterance, an image obtained by capturing an image of the user in at least part of a period from a time when the first utterance ends to a time when the second utterance ends, and biological information of the user that is measured in at least part of the period from the time when the first utterance ends to the time when the second utterance ends.

### (Supplementary Note D5)

The information processing apparatus according to supplementary note D4, wherein in the interruption determination process, the at least one processor determines whether or not to start generation of the second response, by applying an interruption determination method in accordance with the user among a plurality of interruption determination methods for determining whether or not to start generation of the second response.

### (Supplementary Note D6)

The information processing apparatus according to supplementary note D4 or D5, wherein the at least one processor carries out a determination method decision process of deciding an interruption determination method to be applied in next and subsequent interruption determination processes, on the basis of a result of evaluation on the interruption determination method that was applied in the interruption determination process.

### (Supplementary Note D7)

The information processing apparatus according to supplementary note D4 or D5 wherein: an interruption determination method that is applied in the interruption determination process has been determined with use of a method decision model for deciding the interruption determination method; and the at least one processor carries out an optimization process of optimizing the method decision model by carrying out, for each interruption determination method that has been decided with use of the method decision model, a process of updating the method decision model on the basis of a result of evaluation on the interruption determination method that has been decided.

### (Supplementary Note D8)

The information processing apparatus according to any one of supplementary notes D1 to D3, wherein the at least one processor carries out: an emotion estimation process of estimating an emotion of the user in at least part of a period from a time when the first utterance ends to a time when the second utterance ends; and an interruption determination process of determining, on the basis of a result of estimation in the emotion estimation process, whether or not to start generation of the second response.

### [Additional Remark E]

A non-transitory storage medium storing a response program causing a computer to function as an information processing apparatus that makes it possible to respond in natural language to a user with use of a language model trained by machine learning, the response program causing the computer to carry out: a reception process of receiving an utterance of the user; a generation control process of causing the language model to generate a response to the utterance that has been received; and a presentation process of presenting, to the user, the response generated, in a case where a second utterance is received in a period from a time when a first utterance is received to a time when presentation of a first response to the first utterance is completed, the computer being caused to start generation of a second response based on the second utterance and to present, to the user, the second response generated.

### REFERENCE SIGNS LIST

1 information processing apparatus
101 reception unit (reception means)
102 generation control unit (generation control means)
103 presentation unit (presentation means)
1A information processing apparatus
101A reception unit (reception means)
102A generation control unit (generation control means)
103A presentation unit (presentation means)
104A determination method decision unit (determination method decision means)
105A interruption determination unit (interruption determination means)
106A emotion estimation unit (emotion estimation means)
108A optimization unit (optimization means)
111A language model

1. An information processing apparatus that makes it possible to respond in natural language to a user with use of a language model trained by machine learning, said information processing apparatus comprising at least one processor,
the at least one processor carrying out:
a reception process of receiving an utterance of the user;
a generation control process of causing the language model to generate a response to the utterance that has been received; and
a presentation process of presenting, to the user, the response generated,
in a case where the at least one processor receives a second utterance in a period from a time when a first utterance is received to a time when presentation of a first response to the first utterance is completed, the at least one processor starting generation of a second response based on the second utterance and presenting, to the user, the second response generated.

2. The information processing apparatus according to claim 1, wherein the at least one processor presents, to the user, progress information that indicates a state of progress of generation of the first response, in the period from the time when the first utterance is received to the time when presentation of the first response to the first utterance is completed.

3. The information processing apparatus according to claim 2, wherein:
in the generation control process, the at least one processor causes the language model to generate the second response, on a condition that at a time when the second utterance is received, a progress percentage of generation of the first response is less than a predetermined threshold; and
the at least one processor presents, to the user, the predetermined threshold and the progress information that indicates the progress percentage of generation of the first response, during generation of the first response.

4. The information processing apparatus according to claim 1, wherein the at least one processor carries out an interruption determination process of determining whether or not to start generation of the second response, on the basis of at least one selected from the group consisting of content of the second utterance, voice of the second utterance, an image obtained by capturing an image of the user in at least part of a period from a time when the first utterance ends to a time when the second utterance ends, and biological information of the user that is measured in at least part of the period from the time when the first utterance ends to the time when the second utterance ends.

5. The information processing apparatus according to claim 4, wherein in the interruption determination process, the at least one processor determines whether or not to start generation of the second response, by applying an interruption determination method in accordance with the user among a plurality of interruption determination methods for determining whether or not to start generation of the second response.

6. The information processing apparatus according to claim 4, wherein the at least one processor carries out a determination method decision process of deciding an interruption determination method to be applied in next and subsequent interruption determination processes, on the basis of a result of evaluation on the interruption determination method that was applied in the interruption determination process.

7. The information processing apparatus according to claim 4, wherein:
an interruption determination method that is applied in the interruption determination process has been determined with use of a method decision model for deciding the interruption determination method; and
the at least one processor carries out an optimization process of optimizing the method decision model by carrying out, for each interruption determination method that has been decided with use of the method decision model, a process of updating the method decision model on the basis of a result of evaluation on the interruption determination method that has been decided.

8. The information processing apparatus according to claim 1, wherein the at least one processor carries out:
an emotion estimation process of estimating an emotion of the user in at least part of a period from a time when the first utterance ends to a time when the second utterance ends; and
an interruption determination process of determining, on the basis of a result of estimation in the emotion estimation process, whether or not to start generation of the second response.

9. A response method that makes it possible to respond in natural language to a user with use of a language model trained by machine learning, said response method comprising:
at least one processor carrying out a reception process of receiving an utterance of the user;
the at least one processor carrying out a generation control process of causing the language model to generate a response to the utterance that has been received; and
the at least one processor carrying out a presentation process of presenting, to the user, the response generated,
in a case where the at least one processor receives a second utterance in a period from a time when a first utterance is received to a time when presentation of a first response to the first utterance is completed, the at least one processor starting generation of a second response based on the second utterance and presenting, to the user, the second response generated.

10. A computer-readable non-transitory storage medium storing a response program that makes it possible to respond in natural language to a user with use of a language model trained by machine learning, said response program causing a computer to carry out:
a reception process of receiving an utterance of the user;
a generation control process of causing the language model to generate a response to the utterance that has been received; and
a presentation process of presenting, to the user, the response generated,
in a case where a second utterance is received in a period from a time when a first utterance is received to a time when presentation of a first response to the first utterance is completed, the computer being caused to start generation of a second response based on the second utterance and to present, to the user, the second response generated.
